(19) United States
(12) Patent Application Publication
(10) Pub. No.: US 2016/0058062 A1
(43) Pub. Date: Mar. 3, 2016

(54) DEFROSTING SHEET, DEFROSTING METHOD, AND RESTAURANT USING DEFROSTING SHEET

(71) Applicant: Kazuo IWAI, (US)

(72) Inventor: Kazuo IWAI, Shiga (JP)

(21) Appl. No.: 14/761,098

(22) PCT Filed: Dec. 27, 2013
(86) PCT No.: PCT/JP2013/085365

§ 371 Date: Jul. 15, 2015

(30) Foreign Application Priority Data
Jan. 7, 2013 (JP) 2013-011495

(51) Int. Cl. A23L 3/365; B65B 7/02; A23B 4/07

(52) U.S. Cl. CPC A23L 3/365; A23B 4/07; B65B 7/02; A23V 2002/00

(57) ABSTRACT

In conventional defrosting methods such as running water and microwave defrosting, dripping has arisen, affecting flavor and color, and so frozen foods have been evaluated poorly. Also, natural defrosting and refrigerator defrosting require at least two hours, and similarly dripping has arisen and so the reputation has been poor. The objective of the present invention is to perform defrosting of a frozen food such as meat or fish in a short period of time without using thermoelectricity such as electricity. [Solution] This food defrosting sheet is such that a powdered aluminum and a powdered ceramic are mixed with water, a high water absorption polymer or CMC (carboxymethyl cellulose), and hinokitiol, forming a gel, the result is introduced into a bag made of nylon, plastic, or an aluminum sheet, forming a soft sheet, which sandwiches a freezing subject food from the top and bottom, by which means contact area is increased, decreasing dripping arising during defrosting and reducing defrosting time using the heat-absorbing effect of the defrosting sheet for the heat of the frozen food, and so it is possible to decrease changes in color and flavor.

### TECHNOLOGICAL FIELD

The present invention relates to the defrosting of frozen food, and particularly relates to a sheet for defrosting frozen food and particularly a defrosting method so as to defrost frozen meat, fish or the like, particularly frozen sushi rice, more quickly than natural defrosting, without using electricity or another heat source.

### BACKGROUND ART

In recent years, advances have been made in freezing technology, but advances in defrosting technology for frozen food has been lagging. In many cases, the typical method is to use microwave defrosting or running water. With these defrosting methods, meat juice (hereafter referred to as “drips”) occur after defrosting, so this becomes a cause of degradation of the food color and flavor, and is one reason why frozen items are said to be unpalatable. Particularly with microwave defrosting, there was the problem of the flavor degrading due to excessive drying or heating. Natural defrosting is supposed to be optimal, but efficiency is poor since it requires defrosting in the refrigerator or at room temperature (20° C. or less) for two hours or more before use, and it is not possible to prevent the occurrence of drips.

Members that are pillar shaped or plate shaped that have heat transfer properties have been proposed, and defrosting aids have been proposed with these linked so as to work in a designated range (e.g. see Patent Document 1).

### PRIOR ART DOCUMENT

Unexamined Patent Publication No. 2001-231526

### SUMMARY OF THE INVENTION

### Problems the Invention Attempts to Solve

With the defrosting aid of the prior art noted above, the contact area with the subject frozen food was small, so there was the problem of it taking time to defrost. Also, only the part that the frozen food contacted would melt, and the other parts took time to defrost, so as a result, there was unevenness in the defrosted parts, and this gave a bad reputation with the sense that flavor was poor. With the defrosting of frozen foods, the shorter the time, the wider the applications expand, and in addition to having an effect on keeping freshness after defrosting, though the occurrence of drips was low with short time defrosting, with thick steaks, unprocessed fish or the like, there is a thickness or texture, and it was difficult to defrost evenly. Because of this, drips occurred and color and flavor were affected.

The present invention provides a frozen food defrosting sheet or defrosting method that eliminates the problems of aluminum bags or ceramic bags that are the plate shaped food defrosting products described previously, that is able to minimize drips without affecting the frozen food, and can also defrost meat, fish or the like in a short time.

### Means to Solve the Problems

To address the prior art problems noted above, the heat absorbing sheet of the present invention has a constitution for which a gelatinous body for which water is added to a water absorbing polymer or a viscous material for which carboxymethyl cellulose (or carboxymethyl cellulose sodium) (CMC) and water are mixed and a heat absorbing agent for which powdered aluminum or powdered ceramics are mixed are enclosed in a soft bag made of polymer. Also, provided is a heat absorbing sheet for defrosting frozen food constituted using an item for which instead of powdered aluminum or powdered ceramics, one or both of ethylene glycol or propylene glycol is mixed for the heat absorbing material, and also for the gelatinous body, hinokitiol is further contained, an item for which the hinokitiol is added in a volume of 50 ppm to 500 ppm to the water, an item for which the soft bag is a bag of thickness 0.04 mm to 0.1 mm made of vinyl, plastic, or aluminum, an item for which the constitution has thickness of 10 mm to 30 mm and the weight is at least 1 g or more per square centimeter, an item for which the frozen food subject to defrosting is sandwiched from top to bottom and can be folded in two by providing a thin part or a connecting part at the center, or the like.

To resolve the prior art problems noted above, with the defrosting method of the present invention, a defrosting method is provided for which the frozen food subject to defrosting is sushi rice or sushi, the heat absorbing sheet for defrosting frozen food noted above is folded in two, the frozen food subject to defrosting is sandwiched from top and bottom, and the frozen sushi rice, sushi topping, or sushi is defrosted. Also, a defrosting method for frozen food is provided for which the heat absorbing sheet is set to a state at 25 degrees centigrade and sandwiches the frozen food subject to defrosting from top and bottom.

To solve the problems noted above, with the manufacturing method of the heat absorbing sheet of the present invention, each procedure is provided such that two sheets of a vinyl or plastic sheet are cut in a rectangle and overlapped, three sides are thermally processed to close them to have an opening, a heat absorbing material for which one or both of ceramic powder or aluminum powder is mixed with a gelatinous body for which a water absorbing polymer and water are added or a viscous material for which carboxymethyl cellulose (CMC) and water are mixed is placed in the bag, and the opening is bound shut. Furthermore, proposed is a manufacturing method for which a heat absorbing material is used for which one or both of ethylene glycol or propylene glycol is mixed instead of powdered aluminum or powdered ceramics, and for the used water or as a preservative together with the water, hinokitiol included at 50 ppm to 500 ppm to water is used.

To solve the prior art problems noted above, the present invention provides a restaurant that provides food prepared using defrosted sushi rice or sushi topping, or frozen raw meat such as fish or the like. Furthermore, with the restaurant of the invention of this application, using the heat absorbing sheet for defrosting frozen food, the frozen sushi rice or sushi topping, or the frozen raw fish is sandwiched from top and bottom, the frozen sushi rice or sushi topping or the frozen raw meat is defrosted, and food prepared using defrosted sushi rice or sushi topping, or frozen raw meat such as raw fish or the like is provided.

Also, the heat absorbing sheet of the present invention can be utilized not only for defrosting food, but also for applications such as for removing heat from the face or body. For the heat absorbing sheet of the present invention, a sheet is produced including water, aluminum powder and ceramic powder in a base of a high water absorbing polymer in a bag. It is also possible to include so-called fine ceramics such as zirconium silicate, alumina, silica ceramics, silicon carbide or the like. Also, hinokitiol can be included as a preservative. This is placed in the bag in advance so that when the bag breaks, the defrosted food or the gel that is thought to stick to the hand of the person operating it does not spoil. Hinokitiol is also a food additive, and is also used in cosmetics, quasi-pharmaceutical products, and medicines.

With the manufacturing method of the sheet for defrosting frozen food of the present invention, a vinyl sheet, plastic sheet, or aluminum sheet is cut into rectangles, two sheets are overlapped and three sides are heat treated, and a closed back is formed in which a high water absorbing polymer and water are added and ceramic powder or aluminum powder are mixed with this and gelatinized to be uniform, and these are placed so as to be uniform in the bag form described previously. The amount placed inside differs according to the bag, but the part in which the gel is placed is made into a sheet form by closing using heat treatment or the like. At that time, water is used that contains 50 ppm to 500 ppm of hinokitiol as a gel preservative (or mixed to match the timing of mixing the water and ceramic powder). The property of the bag is sufficient as long as it is soft, and it is also possible to use a metal thin film other than aluminum.

### Effect of the Invention

With almost all defrosting plates on the market, the contact surface with the subject frozen food is small, and only the bottom part has contact, so it takes time to defrost. Because of this, it becomes necessary to turn over the subject frozen food once which is troublesome. Also, since the contact surface is small, unevenness occurs with the defrosting, and the problem occurs of not being able to completely defrost. The heat absorbing sheet of the present invention is not a plate shape, but instead is a bag shaped sheet, this is a vinyl, plastic, or aluminum bag for which the thickness of the used bag material is 004 mm to 0.1 mm thick or the like, and this is constituted to be soft with good heat permeability, and by the contact surface with the subject frozen food being larger with two sheets, it is possible to evenly defrost the frozen food, and to shorten the defrosting time.

With the present invention, when also including hinokitiol as a preservative, even if the bag is damaged and the gelatinous body flows out, it is possible to suppress color change and spoilage due to proliferation of bacteria on the food or the like, and defrosting is obtained that has good safety and is very economical. With the present invention, it is possible to defrost frozen food evenly, and also possible to shorten the defrosting time, so it is also possible to defrost packed frozen processed foods, and for example it is possible to obtain this effect also used for frozen mackerel cooked in miso, frozen Spanish mackerel that has been salted, malted and pickled, frozen salmon, frozen mackerel and the like. Also, as frozen items, in addition to raw meat, it can also be used for defrosting frozen articles of beef, pork or chicken, and good quality defrosted meat can be obtained.

### BRIEF DESCRIPTION OF THE DRAWINGS

FIG. 1 (a) is a drawing of a state before using the heat absorbing sheet of an embodiment of the present invention sandwiches the subject frozen food from top to bottom, (b) is a drawing showing the state of sandwiching that subject frozen food from top to bottom, and (c) is a drawing showing a state of the subject frozen food being sandwiched from top to bottom using that same heat absorbing sheet.

FIG. 2 is a flow chart showing the manufacturing steps of the heat absorbing sheet of an embodiment of the present invention.

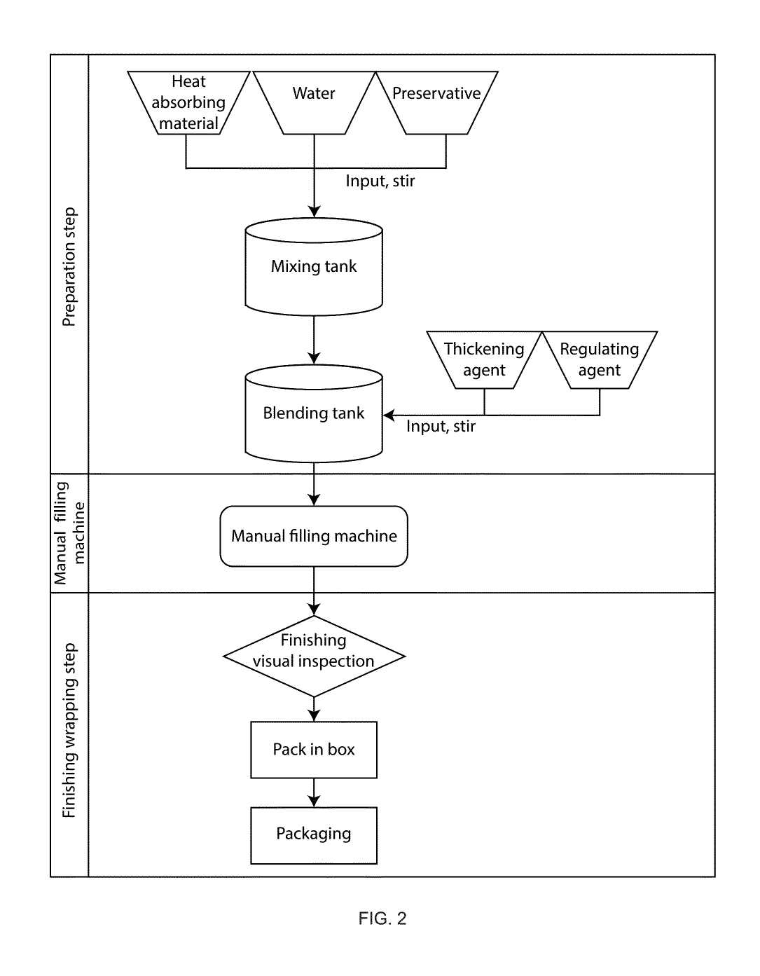

### PREFERRED MODES FOR CARRYING OUT THE INVENTION

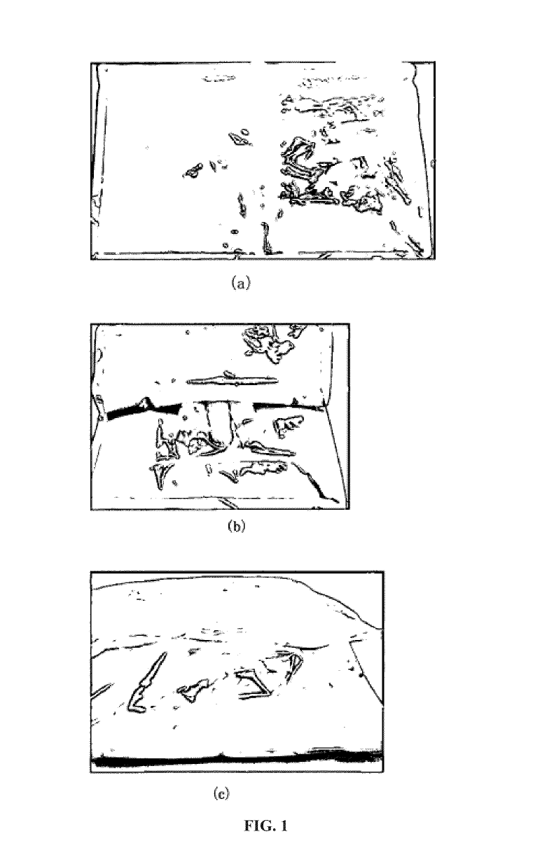

FIG. 1 shows the state of two sheets of the heat absorbing sheet of an embodiment of the present invention being used to sandwich a subject frozen food from top to bottom. Though it differs depending on the size of the frozen food and the size of the sheet, defrosting of the subject frozen food is performed by leaving for from 10 minutes to one hour. At this time, defrosting is performed by the work of the heat absorption energy that the aluminum or ceramic has. Defrosting of the subject frozen food occurs by the heat energy exchange principle by which heat moves from high places to low places. The thickness of the sheet itself is from 10 mm to 30 mmm [sic; this unit of measurement noted as “mmm” consistently throughout the document; translator], and by having a weight of 1 g to 3 g per square centimeter, it is possible to defrost the subject frozen food evenly by increasing the contact surface with two sheets, and also possible to shorten the defrosting time. By directly placing the frozen food on the sheet during defrosting, it is possible to shorten the defrosting time. When hygiene problems occur, it is possible to solve the problem by covering using an item such as thin plastic or vinyl wrap or the like.

In this way, using two sheets of the heat absorbing sheet, by maximizing the contact surface on the subject frozen food, it is possible to shorten the defrosting time. It is also possible to fold one sheet into two and to provide a thin part or a connecting part using the bag member that is easy to fold at the center. Almost all the defrosting plates on the market have a small contact surface with the subject frozen food and only contact the bottom part, so defrosting takes time, and it is necessary to turn the subject frozen food over once, but that is not necessary with this embodiment.

With the manufacturing method of the defrosting sheet for frozen food of the embodiment of the present invention, first, as a stirring step, in a mixing tank, powdered aluminum or powdered ceramics, water, and hinokitiol as a preservative are put in and stirred. Next, the item for which the powdered aluminum or powdered ceramics, the water, and the preservative have been stirred are put into a blending tank, a high water absorbing polymer or CMC (carboxymethyl cellulose sodium) as a thickening agent or a regulating agent are input and stirred, thus mixing the heat absorbing material. With this step, the heat absorbing material becomes a gel having a designated viscosity. In this case, the amount of hinokitiol as a preservative is regulated to be a volume contained at 50 ppm to 500 ppm to water. Next, with the stirring step, with the heat absorbing material filling step, this is evenly filled in a soft bag made of nylon, plastic, or aluminum sheets.

Instead of the combination of powdered aluminum or powdered ceramics, water, a preservative, and CMC (carboxymethyl cellulose (typically used as a food additive)), it is also possible to use a heat absorbing material which is an item combining ethylene glycol or propylene glycol which are antifreeze have a thickening effect (also used as food additives), water, a preservative, and CMC (carboxymethyl cellulose). It is also possible to use a high water absorbing polymer instead of or together with CMC.

The soft bag is an item for which a high water absorbing polymer or a vinyl sheet, plastic sheet, or aluminum sheet is cut into rectangles, two sheets are overlapped, and three sides are heat treated to close this and make a bag. The filling volume of the heat absorbing material differs according to the bag, but after the gel form heat absorbing material is input and the opening parts are closed by heat treatment or the like, a sheet form is formed with four sides bound shut. The properties of the bag are sufficient as long as it is soft, and it is also possible to use a metal thin film other than aluminum. With this embodiment, an aluminum sheet is used, but aside from this, it is also possible to use an aluminum evaporation film or an aluminum foil film, or a film for which plastic such as PET or the like is adhered to those aluminum films.

The heat absorbing sheet obtained in this way is an item constituted in a bag shaped sheet form for defrosting frozen food, the thickness of the used material for the bag is 0.04 mm to 0.1 mm thick made of vinyl, plastic, or aluminum, and is constituted to be a soft item with good heat permeability. The thickness of the sheet itself is formed to be from 10 mm to 30 mmm [sic], and is manufactured designed to have a weight of 1 g to 3 g per square centimeter.

The heat absorbing sheet of the embodiment of the present invention sandwiches the frozen food subject to defrosting with two sheets of the heat absorbing sheet, is able to increase the contact surface, is able to evenly defrost, and is able to shorten the defrosting time. As an effect during defrosting, it is possible to do defrosting by the heat energy heat absorption (moving) effect from the frozen item to the heat absorbing sheet due to heat exchange, so when the temperature of the defrosting sheet of the present invention was raised to around 25° C. at which the food is not affected, it became clear that the defrosting time became even faster. This is due to a phenomenon by which since the difference between the sheet temperature and the heat of the subject frozen food is great, the heat of the frozen food moves to the sheet faster. Specifically, with the heat absorbing sheet (frozen food defrosting sheet) of the present invention, this is constituted with a soft item having good heat permeability (thickness of the sheet itself is from 10 mm to 30 mmm [sic]), the contact surface of the gelatinous body or bag and the frozen food is sufficiently large, and the adhesion is good, so the temperature difference between the subject frozen food temperature during defrosting and the heat absorbing sheet is eliminated, and a phenomenon occurs of the above mentioned drip being decreased.

In the past, at restaurants that offer sushi and the like, the shop management would not go well if there was not a chef on site who could prepare delicious sushi rice or sushi toppings. At the restaurant of the present invention, using the heat absorbing sheet for defrosting frozen food, frozen sushi rice or sushi toppings, or frozen raw meat is sandwiched from top to bottom, the frozen sushi rice or sushi toppings or the frozen raw meat is defrosted, and the defrosted sushi rice or sushi toppings, or the frozen raw meat is used to prepare food. With the present invention, because frozen sushi rice or sushi toppings and raw meat for sashimi can be defrosted with delicious flavor maintained, it is possible to operate a restaurant that offers delicious food using frozen raw meat, sushi rice, or sushi without having to have a skilled chef. Also, in addition to raw fish meat, it is possible to evenly defrost other frozen foods and to shorten the defrosting time, so this can also be used to defrost packed frozen items, for example frozen mackerel cooked in miso, frozen Spanish mackerel that is salted, malted, and pickled, frozen salmon, and frozen mackerel or the like so as to defrost while keeping a delicious flavor. Also, as other frozen articles, it is possible to use this for defrosting frozen beef, pork or chicken in addition to raw fish meat, and possible to use this for restaurants because good quality defrosted meat can be obtained.

### Potential for Industrial Use

With the food defrosting sheet of the present invention, used for the heat absorbing material is an item for which combined are powdered aluminum or powdered ceramic with water and a high water absorbing polymer or CMC (carboxymethyl cellulose), or ethylene glycol or propylene glycol, water, a preservative, and CMC (carboxymethyl cellulose) to which hinokitiol is mixed to make a gel form heat absorbing material, this is placed in a bag which is made into a soft sheet form, and by sandwiching the subject frozen food from top to bottom, the contact surface area is increased and using the heat absorption (heat moving) effect, the defrosting time is shortened, drips are reduced, and it is possible to reduce changes in color and flavor. By using the defrosting sheet of the present invention, compared to conventional defrosting plates, defrosting of meat or fish is performed evenly in a short time, there is less dripping than with microwave or running water defrosting, and there is less changing in flavor and color, so it is possible to reduce the disadvantages that conventional frozen food had by shortening the defrosting time, reducing drips, and reducing food color changes and flavor changes, and this can be used for broad applications not only in the home, but also for industries such as in restaurants and hotels, and izakaya.

1-13. (canceled)

14. A heat absorbing sheet for which a gelatinous body for which a water absorbing polymer and water are mixed or a viscous material for which carboxymethyl cellulose (CMC) and water are mixed, and a heat absorbing material for which powdered aluminum or powdered ceramics are mixed are enclosed in a soft bag made of polymer or metal.

15. The heat absorbing sheet according to claim 14 wherein the gelatinous body further contains hinokitiol.

16. The heat absorbing sheet according to claim 15 wherein the hinokitiol is added to the water in a volume of 50 ppm to 500 ppm.

17. A heat absorbing sheet for which a gelatinous body for which a water absorbing polymer and water are mixed or a viscous material for which carboxymethyl cellulose (CMC) and water are mixed, and a heat absorbing material for which ethylene glycol or propylene glycol are mixed are enclosed in a soft bag made of polymer or metal.

18. The heat absorbing sheet according to claim 17 wherein the gelatinous body further contains hinokitiol.

19. The heat absorbing sheet according to claim 18 wherein the hinokitiol is added to the water in a volume of 50 ppm to 500 ppm.

20. The heat absorbing sheet according to claim 14, wherein the soft bag is a 0.04 mm to 0.1 mm thick bag made of vinyl, plastic, or aluminum.

21. The heat absorbing sheet according to claim 14 constituted so as to have thickness 10 mm to 30 mm and to have a weight of at least 1 g or more per square centimeter.

22. The heat absorbing sheet for defrosting frozen food according to claim 14 wherein a thin part or a connecting part is provided at the center so as to be able to fold in two and sandwich the frozen food subject to defrosting from top and bottom.

23. A defrosting method wherein the frozen food subject to defrosting is sushi rice or sushi, the heat absorbing sheet for defrosting frozen food according to claim 14 is folded in two, the frozen food subject to defrosting is sandwiched from top and bottom, and the frozen sushi rice, sushi topping, or rice is defrosted.

24. The frozen food defrosting method according to claim 23 wherein the frozen food subject to defrosting is sandwiched from top and bottom with the heat absorbing sheet in a state set to 25 degrees centigrade.

25. A manufacturing method of a heat absorbing sheet for which two sheets of a vinyl sheet, plastic sheet, or aluminum sheet cut in a rectangle are overlapped, three sides are closed to make a bag having an opening, and after a heat absorbing material for which one or both of ceramic powder or aluminum powder are mixed in a gelatinous body or a viscous material to which a water absorbing polymer or carboxymethyl cellulose (CMC) and water are added is placed in the bag, the opening is bound shut.

26. The manufacturing method according to claim 25, wherein for the water used when forming the gelatinous body, water is used that contains 50 ppm to 500 ppm of hinokitiol.

27. A manufacturing method of a heat absorbing sheet for which two sheets of a vinyl sheet, plastic sheet, or aluminum sheet cut in a rectangle are overlapped, three sides are closed to make a bag having an opening, and after a heat absorbing material for which one or both of ethylene glycol or propylene glycol are mixed in a gelatinous body or a viscous material to which a water absorbing polymer or carboxymethyl cellulose (CMC) and water are added is placed in the bag, the opening is bound shut.

28. The manufacturing method according to claim 26, wherein for the water used when forming the gelatinous body, water is used that contains 50 ppm to 500 ppm of hinokitiol.
